(19) United States
(12) Patent Application Publication
(10) Pub. No.: US 2002/0029335 A1
(43) Pub. Date: Mar. 7, 2002

(54) Communication protocol for a remote locator system

(76) Inventors: Patrick W. Crockett, Chapel Hill, NC (US); William E. Thacker, Durham, NC (US)

Correspondence Address: Arthur G. Yeager, Suite 1305, 112 West Adams Street, Jacksonville, FL, 32202, US

(21) Appl. No.: 09/907,801

(22) Filed: Jul. 18, 2001

Related U.S. Application Data
(60) Provisional application No. 60/219,785, filed on Jul. 19, 2000.

(51) Int. Cl. G06F 11/30; H04L 9/32

(52) U.S. Cl. 713/151; 380/258; 713/201

(57) ABSTRACT

A method of specifying a communication protocol for reliably and securely communicating location information between a remote locator device and a location service is provided and includes specifying a physical channel layer for the selection of the communication channel over which location information to be communicated is to be transmitted;

specifying a link layer for the selection of the means by which the translation of a coded signal into a form suitable for transmission across the communication channel specified is accomplished;

specifying an encryption/encoding layer for selectively controlling the encryption of location information, for selectively coding the information whether or not it was encrypted, and for selectively following a protocol for dealing with detected errors; and

specifying a content layer for defining the set of all legal messages to be transmitted.

### CROSS REFERENCE TO RELATED APPLICATIONS

This application is related to provisional application, Ser. No. 60/219,785 filed Jul. 19, 2000, “COMMUNICATION PROTOCOL FOR A REMOTE LOCATOR SYSTEM” and is related to a concurrently filed application entitled “TIGHTLY COUPLED REMOTE LOCATION DEVICE UTILIZING FLEXIBLE CIRCUITRY”.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention pertains generally to communication systems, and more particularly to a communication protocol, which is utilized in conjunction with a remote locator system for delivering precise location information on demand.

2. Description of Related Art

In many fields of human endeavor it is useful to know the precise geographic location of a person or object. For example, if an individual is mentally handicapped, it would be desirable to continuously know the individual's exact whereabouts in order to ensure his or her well-being. Similarly, it would be useful to know in real time the location of a delivery person in the field so that more efficient delivery scheduling may be accomplished. A multitude of other applications for geographic location information can be found in the commercial sector, civilian agencies, law enforcement agencies, and the military. With the arrival of the Global Positioning System (GPS), which provides three-dimensional coordinates of any location on earth, such remote locator systems have become a practicality. However, general-purpose data communication protocols are optimized for speed of transmission of large data sets through channels with high signal-to-noise levels. What is needed is a protocol specifically developed for location information transmission through very noisy physical channels and for the maintenance of a high level of secrecy through public channels.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

The sole FIGURE is a protocol flow diagram.

### BRIEF SUMMARY OF THE INVENTION

In one aspect of the present invention there is provided a method of specifying a communication protocol for reliably and securely communicating location information comprising the steps of: specifying a physical channel layer for the selection of the communication channel over which location information to be communicated is to be transmitted; specifying a link layer for the selection of the means by which the translation of a coded signal into a form suitable for transmission across the communication channel specified in step A is accomplished; specifying an encryption/encoding layer for selectively controlling the encryption of location information, for selectively coding the information whether or not it was encrypted, and for selectively following a protocol for dealing with detected errors; and specifying a content layer for defining the set of all legal messages to be transmitted. Additional steps include specifying the physical channel layer to be any communication channel; selecting a modem or a TCP/IP wrapper for the link layer; selecting public key encryption; and selecting symmetric key encryption for the content layer. Other steps include selecting no encryption and selecting no encoding. Also, there are the steps of establishing a fixed set of legal messages to include agreement/denial to encryption and error-detecting algorithms and keys; a negotiated set of legal messages; the notification that all tasks for a communication session have been completed (session termination signal); the identification data for the source of location data; location data; and the number of times location data has been acquired/generated.

In other aspects of the present invention there is provided a method of specifying a communication protocol for reliably and securely communicating location information between at least one movable locator device having the capability of determining its location and a locator service including the steps of: specifying a physical channel layer for the selection of the communication channel over which location data from at least one locator device is to be transmitted to a locator service; specifying a link layer for the selection of the means by which the translation of a coded signal into a form suitable for transmission across the communication channel specified in step A is accomplished; specifying an encryption/encoding layer for selectively controlling the encryption of location information from one locator device for selectively coding the information whether or not it was encrypted, and for selectively following a protocol for dealing with detected errors; and specifying a content layer for defining the set of all legal messages to be transmitted between a locator device and a locator system. Additional steps include specifying the physical channel layer to be any communication channel; selecting a modem for the link layer; selecting a TCP/IP wrapper for converting character streams into TCP/IP packets for the link layer; selecting public key encryption for transmission of information regarding the identity of a locator device; selecting symmetric key encryption for the content layer; selecting no encryption; and selecting no encoding.

Other steps include establishing a fixed set of legal messages to include the specification of and agreement/denial to encryption and error-detecting algorithms and keys; the specification of a negotiated set of legal messages; the notification that all tasks for a communication session have been completed (session termination signal); identification data for the source of location data as a legal message; location data; and number of times location data has been acquired/generated.

Another aspect of the present invention includes a communication protocol for the communication of location information from a locator device and a locator service comprising a physical channel layer for transmission of data, a link layer for translating location data into a signal for transmission of the location data through the physical channel layer, an encryption/encoding layer for selectively controlling the encryption of the location information and coding encrypted location information in an error-detecting code, and a content layer for defining a set of all legal messages to be transmitted through the physical channel layer.

### DETAILED DESCRIPTION OF THE INVENTION

Definitions

A remote locator system consists of one or more locator devices, a protocol for communicating with the locator devices, and a service (protocol, software, and hardware) for delivering location information (from the locator devices) on demand.

A remote locator device is an electronic assembly that has a means for establishing its location and an ability to communicate that location to a querying agent.

Purpose—This is a protocol 10 that provides a standard for reliable and secure communication between a locator device 11 and a locator service 12.

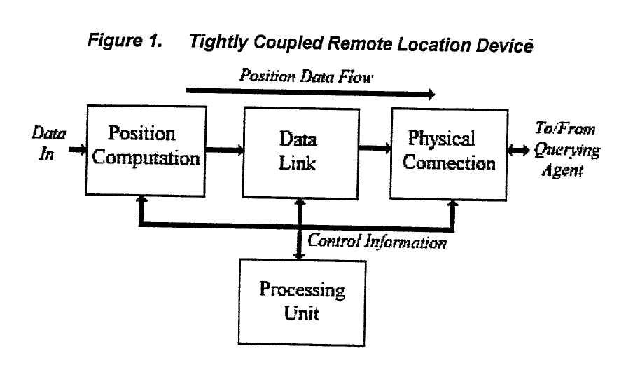

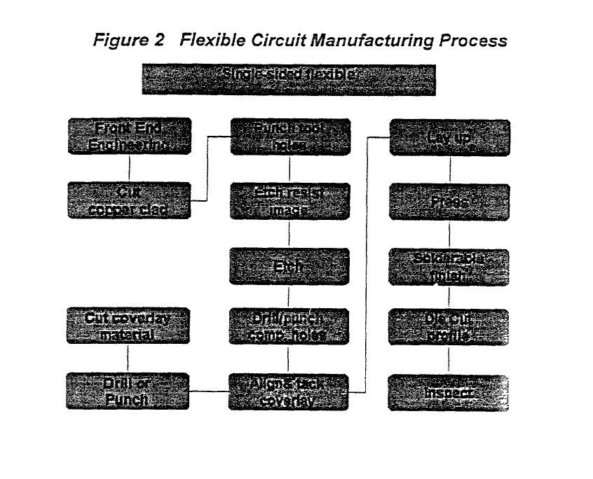

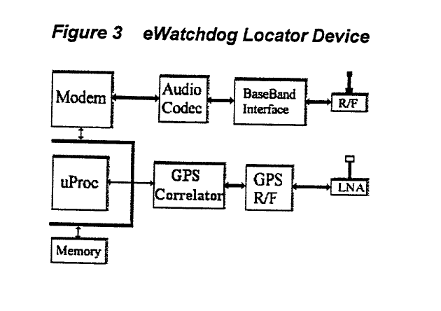

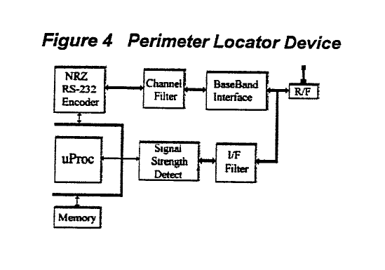

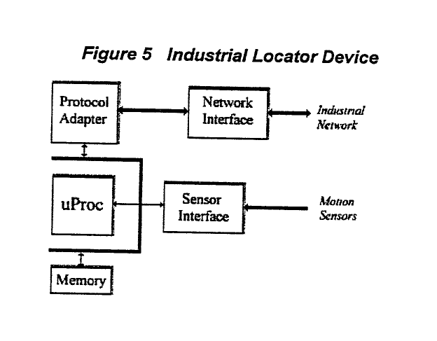

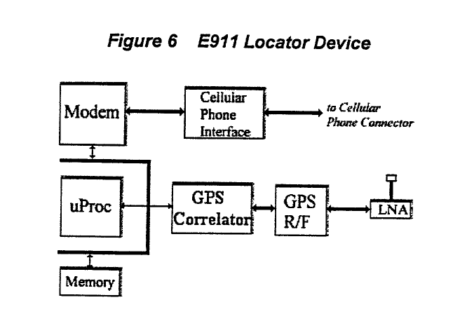

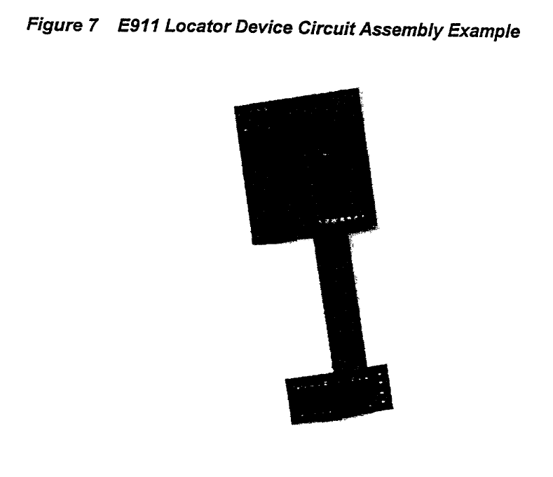

Parts—The protocol 10 is a specification of four communication layers for the specific purpose of reliably and securely communicating location information (FIG. 1). The layers are:

1. Physical channel layer 13. This may be any communication channel 14. Examples include (but are not limited to):

i. Internet,

ii. cellular telephone network,

iii. other wireless broadcast,

iv. direct wire connection,

v. optical cable connection.

2. Link layer 15. This layer translates a coded digital signal into a form suitable for transmission across the physical communication channel. Examples include (but are not limited to):

i. a modem for converting digital character streams to analog signals for transmission over telephone systems,

ii. a TCP/IP wrapper for converting character streams into TCP/IP packets.

3. Encryption/encoding layer 16. This layer ensures reliability and security of communication by encrypting content in an encryption scheme, by coding the encrypted data in an error-detecting code, and by following a protocol for handling detected errors. Examples of encryption include (but are not limited to):

i. public key encryption for establishing identities of the locator device and the locator service, followed by symmetric key encryption of content,

ii. no encryption for physically secure communication channels such as direct wire connection or for applications where there is no anticipated benefit from secure communication.

Examples of error-detecting coding include (but are not limited to):

i. MNP, V.42, cyclic redundancy, checksum

ii. no encoding for low-noise channels or channels that include error detection capabilities adequate for the specific application.

Examples of error-handling protocols include (but are not limited to):

i. retransmission of blocks with errors,

ii. correction of errors using information contained in error-correcting codes, iii. ignoring blocks containing errors.

4. Content layer 17. The content layer is the explicitly defined set of all legal messages. Legal messages include (but are not limited to):

i. administrative messages,

ii. location data,

iii. concomitant data,

iv. requests for data,

v. instructions.

Examples of administrative messages include (but are not limited to):

i. specification of and agreement/denial to encryption and error-detecting algorithms and keys,

ii. specification of a negotiated set of legal messages (in addition to the fixed set of legal messages),

iii. notification that all tasks for a communication session have been completed (session termination signal),

iv. alerts (examples of alerts include, but are not limited to: notification of low battery status, and notification of a panic situation),

v. identification,

vi. acknowledgements.

Examples of concomitant data include (but are not limited to):

i. battery level,

ii. number of GPS satellites detected,

iii. times that location data were acquired/generated.

The present invention is the first data communication protocol to specify a complete content-to-physical-channel protocol explicitly for the communication of location information. Other, general purpose, data communication protocols are optimized for speed of transmission of large data sets through channels with high signal-to-noise ratios. The protocol 10 emphasizes accuracy of communication of information required by locator systems; that is, communication of limited instruction sets and small data sets; the protocol 10 is more useful than existing data communication protocols for communicating location information through a very noisy physical channel, and for communicating location information with extreme privacy through a very public physical channel.

The communication from a device 11 to the service 12 begins by establishing a connection across the communication channel from block 18 to block 22 that preferably represent respective modems.

Data from block 19 is then encrypted at block 20 and converted into an error-detecting code at block 21. The data signal is then converted at block 18 into the appropriate form for transmission through channel 14 to block 22. The signal is converted to a character stream before being sent to block 23 where it is decoded. Block 25 represents the appropriate action taken if an error is detected via a selected error-handling protocol. The signal is then decrypted at block 24 before being sent to block 26, which may represent memory or further processing into a usable form (such as being placed on a computer screen).

Communication between the service 12 and a device 11 is fundamentally the same. Block 27 establishes communication with block 31. Data from block 28 is encrypted at block 29, coded for error detection at block 30 and sent to channel 14 via an appropriate form created at block 27.

The received signal is converted into a character stream at block 31 and decoded at block 32. Any errors detected are dealt with via error handling protocol 34. Decryption occurs at block 33. The data is stored in this device at block 35.

### EXAMPLE IMPLEMENTATIONS

Implementations of the location communication protocol include (but are not limited to) the following examples.

### Example 1

Personal Locator System.

In this example, the locator device 11 is a self-contained unit combining:

a battery, global positioning (GPS) antenna and circuitry, cellular telephone antenna and circuitry, modem circuitry, on-board memory for storing data for 100 locations (including latitude, longitude, elevation, time, and number of satellites contributing to the location fix), logical processing capability (a CPU).

The locator device 11 also has a panic button that the carrier may press in an emergency.

The locator service 12 delivers location information to clients via three modes: World Wide Web, human telephone center operators, and an automated voice response system. Through any of the modes, a client can:

1. request the current location of his device 11,

2. request the stored past locations,

3. instruct the device 11 to store locations either at fixed time intervals (which intervals he specifies) or

4. as the device 11 moves a fixed distance (which he specifies) from the most recently stored location.

When any of these actions is initiated, the service 12 telephones the device 11 (through the service's modem 27 and the device's cell phone) issues the instruction or requests the data, and then delivers the data to the client in suitable format.

If the device's battery level falls below a prescribed level, the device 11 calls a specified primary phone number to inform the service 12 that the battery is low and to download the stored location data. Then the device 11 becomes dormant until the battery is recharged.

If the panic button is pressed, the device 11 calls a specified secondary phone number to inform the service 12 that an emergency is occurring. The service 12 then alerts the appropriate agency (PSAP and/or the client) and requests the device's current location at short intervals until the emergency is over.

Before a personal locator device can be put into service, it must be initialized or registered with the locator service. This is done via the device's cell phone in a call initiated by the device 11. The device 11 is provided (by its manufacturer) with an electronic serial number (ESN) that is unique to that specific device. The device 11 also knows:

1. whether it has been assigned a mobile identification number (MIN—its cell phone number) and a cellular home system identification number (SID) by a cellular phone service provider;

2. its MIN and SID if they have been assigned,

3. its manufacturer's identification code,

4. its manufacturer's private encryption key (for a public key encryption algorithm),

5. its manufacturer's public encryption algorithm,

6. the service's public encryption (for the public key encryption algorithm),

7. a symmetric key encryption algorithm, the algorithm's identification code, and the device's unique encryption key,

8. the error-detecting algorithm used by the service 12,

9. the initialization phone number for the service 12.

The service 12 knows:

1. the public key and encryption algorithm associated with every manufacturer's identification code,

2. the symmetric encryption algorithm associated with every symmetric encryption identification code,

3. primary and secondary phone numbers for the device 11 to call

4. appropriate, available MIN and SID for the device 11 if these have not already been assigned.

Protocol for communicating with a personal locator device.

Part 1, Initialization.

The physical communication channel layer 13 is the cellular telephone network and the telephone network between the cellular telephone service provider and the locator services physical location.

The link layer 15 is an onboard modem 18 using a standard low-level modulation protocol such as V.34, V.32bis, V.32, V.22bis, or V.22.

For the initial phase of the initialization call, the encryption/encoding layer 16 will be encryption-null (no encryption, error-detection encoding with the algorithm used by the service 12). As communication is established and an encryption algorithm is negotiated, the encryption/encoding layer 16 will convert (in stages, as described in the following description of an initialization call) to the agreed upon encryption algorithm 20, 29. An error in the initialization call at 25 will require re-transmission of the block containing the error. After five unsuccessful attempts to transmit a block error-free, the initialization call will be terminated by the service 12.

The content layer 17 consists of the legal instructions and data identified in the following description of an initialization call.

Description of an Initialization Call.

Once modem 18, 22 handshaking has been completed, the device 11 will send a four-character device manufacturer identification code (unencrypted). (The four-character length is before encoding for error detection.) Each manufacturer's identification code will be agreed upon in advance by the manufacturer and the owner of the service 12. An unrecognized code is an error.

Next the device 11 will send a code identifying a symmetric encryption algorithm and an encryption key. The algorithm code and the key will both be encrypted 20 with a standard public key encryption algorithm (such as PGP) using both the service's public key and the device manufacturer's private key. One encryption algorithm code will specify that no encryption will be used. An unrecognized encryption identification code is an error.

If a symmetric encryption algorithm is specified, it will be used for the remainder of the initialization process.

All data and codes described below are part of the content layer 17. When the call description says that the device 11 will send a particular code or datum, this means that the code or datum is first encrypted 20, then encoded for error detection 21, then modulated 18, then transmitted via channel 14.

The device 11 next sends its ESN, and a three-character code identifying the device type. This device type code will allow the protocol to be used for specialized devices (with some standard features disabled or with non-standard features added) as well as for the standard devices. An unrecognized device type code is an error.

The next information the device 11 will send is a code indicating whether the device has already been assigned an SID and an MIN by a cellular phone service provider. If an SID and an MIN have been assigned, the device will also send these numbers to the service. An illegal SID or MIN is an error.

The service 12 will respond (using the specified encryption algorithm and key) by sending the device 11 an SID and an MIN (if the device 11 does not already have these), and sending primary and secondary telephone numbers (which the device 11 may use to contact the service 12 for subsequent communication sessions).

The service 12 will then send a call termination code and terminate the call.

In summary, for initialization the device 11 sends the following data to the service:

1. Device manufacturer identification code (unencrypted).

2. Symmetric encryption algorithm identification code (using public key encryption).

3. Symmetric encryption key (using public key encryption).

4. ESN (using symmetric encryption).

5. Code identifying device type (using symmetric encryption).

6. Code indicating whether device has been assigned SID and MIN (using symmetric encryption).

7. (If SID and MIN have been assigned) SID (using symmetric encryption).

8. (If SID and MIN have been assigned) MIN (using symmetric encryption).

The service responds by sending the following data to the device:

9. (If SID and MIN have not been assigned) SID (using symmetric encryption).

10. (If SID and MIN have not been assigned) MIN (using symmetric encryption).

11. Primary telephone number for contacting service (using symmetric encryption).

12. Secondary telephone number for contacting service (using symmetric encryption).

When the initialization call has been successfully completed, the service 12 will call the device 11 and issue each legal instruction and data request (defined below) to test the initialization and will instruct the device 11 to call the primary and secondary phone numbers. If the instruction and data requests are correctly received by the device 11, if the data transmitted by the device 11 is correctly received by the service 12, and if the primary and secondary phone numbers are successfully called by the device 11 within ten (10) minutes, then the device 11 is initialized. Otherwise the client is notified that initialization failed.

Part 2: Communicating With an Initialized Personal Locator Device.

The physical communication channel layer 13 is the cellular telephone network and the telephone network between the cellular telephone service provider and the locator services physical location.

The link layer 15 is an onboard modem using a standard low-level modulation protocol such as V.34, V.32bis, V.32, V.22bis, or V.22.

For calls initiated by the service 12, the encryption/encoding layer 16 will be the symmetric encryption algorithm 29 agreed upon during initialization, and the service's error-detecting algorithm 30. Calls initiated by the device 11 will begin with null-encryption and switch to the agreed-upon symmetric encryption algorithm 20 as soon as the service 12 correctly acknowledges receipt of a registered ESN. Device-initiated calls will use the service's error-detecting algorithm 20, 29 throughout. An error in recognition of the call-initiator (device or service) will require retransmission. After five unsuccessful attempts, the call will be terminated. Other errors will result in a single attempt to retransmit. If retransmission is unsuccessful, the particular request, data transfer, or instruction will be abandoned and the call will continue.

The procedure for re-establishing communication if a call is interrupted before all tasks have been completed (a missing call-terminator code error) is:

1. If a service initiated communication session is interrupted before the call-terminator is sent and acknowledged, the session will be re-initiated by the service 12.

2. If a device 11 initiated communication session is interrupted before the service 12 has acknowledged the device ESN, the device 11 will re-initiate the session.

3. If a device 11 initiated communication session is interrupted after the service 12 has acknowledged the device ESN, but before the call-terminator is sent and acknowledged, the service 12 will re-initiate the session.

The content layer 17 consists of the instructions and data identified in the following descriptions of calls.

Description of a Service-initiated Communication Call.

The service 12 may initiate a call to poll the device 11 for its location (current and/or past), to instruct the device on appropriate time intervals or distance intervals for saving past locations, or to toggle the device between standard and emergency states.

After the modem 27, 31 handshaking has been completed, the service 12 will send a signature and the device 11 will acknowledge that the signature is genuine. Then the service will send instruction codes and parameters 28 (where needed) to the device 35 and the device 11 will respond 19 by sending requested data or by acknowledging the instruction (if the instruction is not a request for data). Data, commands, and acknowledgements are all encrypted 20 using the specified symmetric encryption algorithm 20, 29 and coded using the service's error-detecting algorithm 30.

The service 12 will send one instruction code and accompanying parameters, wait for the device 11 to send data or acknowledgement, and then send the next code and parameters. When all instructions have been sent and acted upon, the device 12 will send a code that terminates the session.

The set of instructions and parameters correspond to the entries of Table 1.

TABLE 1

| Instruction | Parameters | Action |
|---|---|---|
| Send location | None | Send most recent latitude, |
| | | longitude, elevation, time of fix, |
| | | and number of satellites in fix. |
| Send past | None | Send latitudes, longitudes, |
| locations | | elevations, times, numbers of |
| | | satellites for all saved locations, |
| | | starting with the most recent. |
| Send battery | None | Send status of battery. |
| status | | |
| Set time | Time interval | Acknowledge receipt of |
| interval | | instruction, set interval of time |
| | | between saved locations. |
| Set distance | Distance Interval | Acknowledge receipt of |
| interval | | instruction, set interval of |
| | | distance between saved locations. |
| Set state | New state | Acknowledge receipt of (emergency |
| | | or standard) instruction, set state of |
| | | device. |

Description of a Primary Device-initiated Call.

The device 11 initiates a call to the primary phone number to notify the service 12 that the device's battery is low.

After modem handshaking is completed, the device will send its ESN using public-key encryption with the service's public key. If the ESN is properly registered (via initialization), the service 12 will respond by sending the ESN back, encrypted using the symmetric encryption algorithm and key specified when initializing the device.

Next the device 11 will send the latitudes, longitudes, elevations, times, and numbers of satellites for the saved locations, starting with the most recent. When the data has all been sent and received without error, the service 12 will send a code to terminate the communication session.

Description of a Secondary Device-initiated Call.

The device 11 initiates a call to the secondary phone number to alert the service 12 that the device carrier has pressed the panic button. After modem 18, 22 handshaking is completed; the device 11 will send its ESN using public-key encryption with the service's public key. If the ESN is properly registered (via initialization), the service 12 will respond by sending the ESN back, encrypted using the symmetric encryption algorithm and key specified when initializing the device.

Next the device will send the latitude, longitude, elevation, time, and number of satellites for the most recent location. The service 12 will acknowledge, and then the device 11 will await instructions from the service 12. When appropriate, the service 12 will send a code to terminate the session.

### Example 2

Web-enabled PDA Anti-theft System.

In this example the locator device 11 is embedded within a web-enabled personal digital assistant. The device includes a GPS antenna and circuitry and logic embodying the communication protocol. Each time the PDA logs onto the Internet, it contacts the locator service's website to give the service 12 its electronic serial number (ESN). If the PDA has been reported as stolen, the service 12 will query the PDA for its location and report it to the appropriate authority. All of this is done in the background, invisibly to the PDA user.

Protocol for Communicating With a PDA Anti-theft Locator Device.

The physical communication channel layer 13 is made up of the PDA's Internet access and the Internet 14. The link layer 15 consists of the PDA's TCP/IP and browser implementations.

The encryption/encoding layer 16 consists of the PDA's encryption and error-detecting algorithms. The content layer 17 consists of the message informing the service of the device's ESN, the request for the current location, and the current latitude, longitude, and elevation.

With obvious modifications of the physical channel layer, link layer, and encryption/encoding layer, this protocol will also be useful for communicating with laptop computer anti-theft devices and cellular telephone anti-theft devices.

### Example 3

Robotic Manufacturing Gofer.

In this example, the locator device 11 is embedded within an independently mobile robot that keeps manufacturing machines stocked with parts and materials from a central supply source. The computer that controls the manufacturing process also controls the robot. The robot determines its location through triangulation from signal emitters placed around the factory or through a floor level laser grid. The robot communicates with the control computer through a wire cable that drops from a retractor in the ceiling or through a wireless connection.

Protocol for Communicating With a Manufacturing Gofer's Locator Device.

The physical communication channel layer 13 is the cable or wireless connection 14.

The link layer 15 is a TCP/IP implementation or a serial port protocol.

The encryption/encoding layer 16 is null-encryption and null-encoding.

The content layer 17 consists of the request for the current location, and the current location. With obvious modifications, this protocol will be useful for communicating with cleaning robots (vacuums or mops) and with lawn mowing robots.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A method of specifying a communication protocol for reliably and securely communicating location information comprising the steps of:
A. specifying a physical channel layer for the selection of the communication channel over which location information to be communicated is to be transmitted;
B. specifying a link layer for the selection of the means by which the translation of a coded signal into a form suitable for transmission across the communication channel specified in step A is accomplished;
C. specifying an encryption/encoding layer for selectively controlling the encryption of location information, for selectively coding the information whether or not it was encrypted, and for selectively following a protocol for dealing with detected errors; and
D. specifying a content layer for defining the set of all legal messages to be transmitted.

2. The method of claim 1 wherein step A includes the step of:
E. specifying the physical channel layer to be any communication channel.

3. The method of claim 1 wherein step B includes the step of:
E. selecting a modem or a TCP/IP wrapper.

4. The method of claim 1 wherein step C includes the step of:
E. selecting public key encryption.

5. The method of claim 1 wherein step C includes the step of:
E. selecting symmetric key encryption for the content layer of step D.

6. The method of claim 1 wherein step C includes the step of:
E. selecting no encryption.

7. The method of claim 1 wherein step C includes the step of:
E. selecting no encoding.

8. The method of claim 1 wherein step D includes the step of:
E. establishing a fixed set of legal messages.

9. The method of claim 8 wherein step D further includes the step of:
F. defining the specification of and agreement/denial to encryption and error-detecting algorithms and keys as a legal message.

10. The method of claim 8 wherein step D further includes the step of:
F. defining the specification of a negotiated set of legal messages as a legal message.

11. The method of claim 8 wherein step D further includes the step of:
F. defining the notification that all tasks for a communication session have been completed (session termination signal) as a legal message.

12. The method of claim 8 wherein step D further includes the step of:
F. defining the identification data for the source of location data as a legal message.

13. The method of claim 8 wherein step F includes the step of:
F. defining location data as a legal message.

14. The method of claim 13 wherein step F includes the step of:
G. defining the number of times location data has been acquired/generated as a legal message.

15. A method of specifying a communication protocol for reliably and securely communicating location information between at least one movable locator device having the capability of determining its location and a locator service including the steps of:
A. specifying a physical channel layer for the selection of the communication channel over which location data from at least one locator device is to be transmitted to a locator service;
B. specifying a link layer for the selection of the means by which the translation of a coded signal into a form suitable for transmission across the communication channel specified in step A is accomplished;
C. specifying an encryption/encoding layer for selectively controlling the encryption of location information from one locator device for selectively coding the information whether or not it was encrypted, and for selectively following a protocol for dealing with detected errors; and
D. specifying a content layer for defining the set of all legal messages to be transmitted between a locator device and a locator system.

16. The method of claim 15 wherein step A includes the step of:
E. specifying the physical channel layer to be any communication channel.

17. The method of claim 15 wherein step B includes the step of:
E. selecting a modem.

18. The method of claim 15 wherein step B includes the step of:
E. selecting a TCP/IP wrapper for converting character streams into TCP/IP packets.

19. The method of claim 15 wherein step C includes the step of:
E. selecting public key encryption for transmission of information regarding the identity of a locator device.

20. The method of claim 15 wherein step C includes the step of:
E. selecting symmetric key encryption for the content layer of step D.

21. The method of claim 15 wherein step C includes the step of:
E. selecting no encryption.

22. The method of claim 15 wherein step C includes the step of:
E. selecting no encoding.

23. The method of claim 15 wherein step D includes the step of:
E. establishing a fixed set of legal messages.

24. The method of claim 23 wherein step D further includes the step of:
F. defining the specification of and agreement/denial to encryption and error-detecting algorithms and keys as a legal message.

25. The method of claim 23 wherein step D further includes the step of:
F. defining the specification of a negotiated set of legal messages as a legal message.

26. The method of claim 23 wherein step D further includes the step of:
F. defining the notification that all tasks for a communication session have been completed (session termination signal) as a legal message.

27. The method of claim 23 wherein step D further includes the step of:
F. defining the identification data for the source of location data as a legal message.

28. The method of claim 23 wherein step E includes the step of:
F. defining location data as a legal message.

29. The method of claim 28 wherein step F includes the step of:
G. defining the number of times location data has been acquired/generated as a legal message.

30. A communication protocol for the communication of location information from a locator device and a locator service comprising a physical channel layer for transmission of data, a link layer for translating location data into a signal for transmission of said location data through said physical channel layer, an encryption/encoding layer for selectively controlling the encryption of said location information and coding encrypted location information in an error-detecting code, and a content layer for defining a set of all legal messages to be transmitted through said physical channel layer.
